(19) United States
(12) Patent Application Publication
(10) Pub. No.: US 2017/0200391 A1
(43) Pub. Date: Jul. 13, 2017

(54) A VISUAL TRAINING SYSTEM AND A METHOD THEREOF

(71) Applicant: Chetan MISRA, New Delhi (IN)

(72) Inventor: Chetan MISRA, New Delhi (IN)

(21) Appl. No.: 15/325,028

(22) PCT Filed: Jul. 8, 2015
(86) PCT No.: PCT/IB2015/055169

§ 371 Date: Jan. 9, 2017

(30) Foreign Application Priority Data
Jul. 8, 2014 (IN) 1877/DEL/2014

(51) Int. Cl. G09B 19/00; A63F 13/2145; A63F 13/35; A63B 69/00; A63F 13/67; A63F 13/812; A63F 13/90; G09B 5/02; A63F 13/213; A63F 13/46

(52) U.S. Cl. CPC G09B 19/0038; A63F 13/213; A63F 13/2145; A63F 13/35; A63F 13/46; A63F 13/67; A63F 13/812; A63F 13/90; G09B 5/02; A63B 69/00; A63B 69/002

(57) ABSTRACT

An adaptive sport training system is disclosed. The adaptive sport training system comprises of a first screen and a second screen in communication with each other, a target rendering module configured to display a target on the first screen and the second screen, a target impact sensor module configured to sense impact of an object on the first screen and the second screen and to determine a proximity of impact to the target, and a processor configured to generate an impact score based on the proximity of the impact to the target, wherein the target rendering module is configured to display a subsequent target on the first screen based on the impact score for the first screen and the impact score for the second screen.

The present invention discloses an adaptive sports training and evaluation system. Such adaptive sport training and evaluation system is employed for training both single and multiple players.

### BACKGROUND

Visual simulators are used for interactive games, professional presentations, education and learning purposes, and in sports and fitness activities. These visual simulators can be set up in different environments and can be programmed to help a user or a player to perform his simulated task. They are also used to assess the user's ability for the task performed, such as for physical activities in sports.

Also, sports simulation training equipment are available for different types of sports such as soccer, American football, baseball, golf etc. for coaching and training purposes. Most of the sports simulation systems are based on laser/LED light indicators for rendering target on screen solutions having the capability of sensing impact on the screen. Further, the training equipment are capable of assessing players' skills such as the energy with which target is stuck on the screen and the force impact on the screen.

The available simulators are usually designed to entertain and train a limited number of players at a time on a single interactive screen. Also, they are exposed to various visual simulations for real sports experience. Such experiences is often for fun based virtual interactive games and do not involve real time physical fitness training systems required for players for a particular sport. Although, the existing sports training systems, such as for football or soccer, implement installations of high wall panels in a wide field area, so that the players can physically run in that closed field area to practice the sport, such installations often involve high setting up and maintenance cost. Further, advanced sensor systems for sensing the impacts on the simulated wall panels throughout the field area are required to assess and train the players, these advanced sensor systems involve further configuration cost.

In view of the prior art, visual training systems are desired which are capable of training multiple players in a real time sports environment and also address the fitness levels of the players required for a particular sport. Further, such systems should be cost effective, and have simple implementation.

### SUMMARY

An adaptive sport training system is disclosed. The adaptive sport training system comprises of a first screen and a second screen in communication with each other, a target rendering module configured to display a target on the first screen and the second screen, a target impact sensor module configured to sense impact of an object on the first screen and the second screen and to determine a proximity of impact to the target, and a processor configured to generate an impact score based on the proximity of the impact to the target, wherein the target rendering module is configured to display a subsequent target on the first screen based on the impact score for the first screen and the impact score for the second screen.

### BRIEF DESCRIPTION OF DRAWINGS

FIG. 1 shows a target impact sensor module in accordance with an embodiment of the present disclosure.

FIGS. 2 and 3 shows screens displaying a target in accordance with an embodiment of the present disclosure.

FIGS. 4, 5 and 6 shows a plurality of cubes arranged as cubes in accordance with embodiments of the present disclosure.

FIG. 7 shows screens arranged in the form of a cube displaying subsequent target on the next screen of the cube in accordance with an embodiment of the present disclosure.

FIG. 8 shows screens arranged in the form of multiple cubes displaying subsequent target on the screens of the next cube in accordance with an embodiment of the present disclosure.

FIG. 9 shows an adaptive sport training system in accordance with an embodiment of the present disclosure.

FIG. 10 shows two screens, each displaying target in accordance with an embodiment of the present disclosure.

FIG. 11 shows four screens, each displaying target in accordance with an embodiment of the present disclosure.

FIG. 12 shows a user interface representing an evaluation report generated by the evaluation module in accordance with an embodiment of the present disclosure.

### DETAILED DESCRIPTION

It will be understood by those skilled in the art that the foregoing objects and the following description of the nature of invention are exemplary and explanatory of the invention and are not intended to be restrictive thereof.

For the purpose of promoting an understanding of the principles of the invention, reference will now be made to various alternative embodiments and specific language will be used to describe the same. It will nevertheless be understood that no limitation of the scope of the invention is thereby intended, such alterations and further modifications in the illustrated method and system, and such further applications of the principles of the invention as illustrated therein being contemplated as would normally occur to one skilled in the art to which the invention relates.

It will be understood by those skilled in the art that the following description is exemplary and explanatory of the invention and are not intended to be restrictive thereof.

Many of the functional units described in this specification have been labeled as modules, in order to more particularly emphasize their implementation independence. For example, a module may be implemented as a hardware circuit comprising custom very large scale integration circuits or gate arrays, off-the-shelf semiconductors such as logic, chips, transistors, or the other discrete components. A module may also be implemented in programmable hardware devices such as field programmable gate arrays, programmable array logic, programmable logic devices or the like.

Modules may also be implemented in software for execution by various types of processors or microprocessors. An identified module of executable code may, for instance, comprise one or more physical or logical blocks of computer instructions which may, for instance, be organized as an object, procedure, or function. Nevertheless, the executable of an identified module need not be physically located together, but may comprise disparate instructions stored in different locations which, when joined together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data maybe collected as a single data set, or may be distributed over different locations including over different member disks, and may exist, at least partially, merely as electronic signals on a system or network.

Reference throughout this specification to “one embodiment” “an embodiment” or similar language means that a particular feature, structure, or characteristic described in connection with the embodiment is included in at least one embodiment of the present invention. Thus, appearances of the phrase “in one embodiment”, “in an embodiment” and similar language throughout this specification may, but do not necessarily, all refer to the same embodiment.

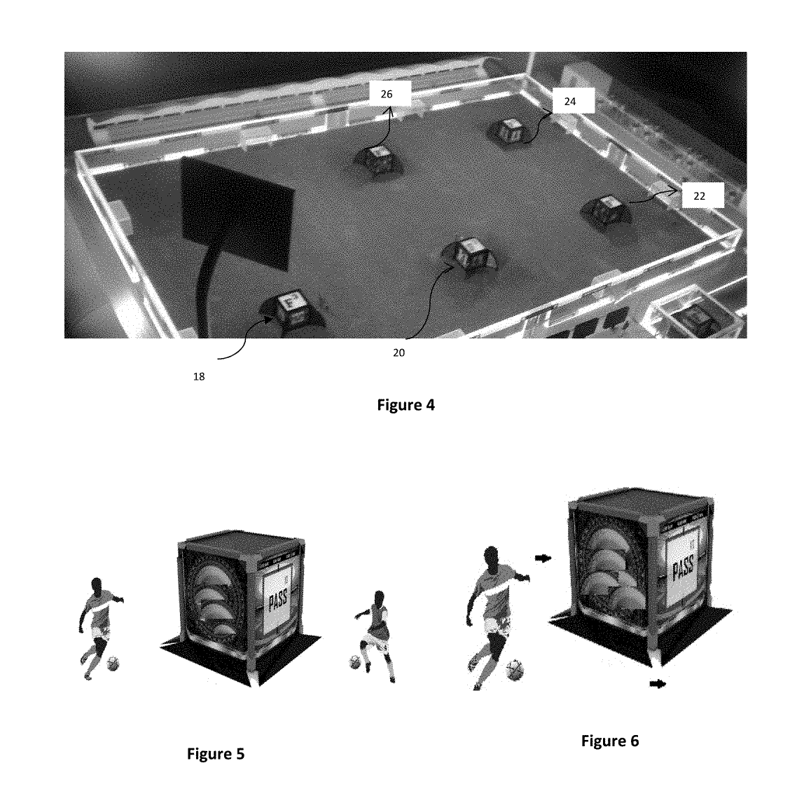

An adaptive sport training system is disclosed. Such adaptive sport training system is used to train a single player as well as multiple players. In accordance with an embodiment, the adaptive sport training system includes audio visual modules to display suitable graphical user interfaces and play interactive audios to interact with one or more players. Further, the adaptive sport training system comprises of a first screen and a second screen in communication with each other. In accordance with a further embodiment, the adaptive sport training system comprises of three or more screens in communication with each other. According to a preferred embodiment, the three or more screens, referred to as the ‘plurality of screens’ hereafter, are arranged adjacent to each other or are arranged in the form of a cube, or multiple cubes placed across a field. The multiple cubes can be as many as desired to involve multiple players and can be spread apart at suitable distances, required for a physical fitness involved in a sport. For example, FIG. 4 is an example of multiple cubes, wherein 5 cubes, 18, 20, 22, 24 and 26, are placed across a football field. In another FIG. 5, an example of multiple players playing on different screens of the same cube is shown, in FIG. 5 two players are shown on two screens of the same cube. Further, in FIG. 6, an example of a single player playing on all the screens of the cube is shown, In FIG. 6, a single player is shown playing on one of the screens of the cube, the same player shall move to the next screen of the cube, when prompted (shown with arrow marks) according to the teachings of the present disclosure.

Further, the communication between the screens can either be an IP network, a LAN implementation, a wireless network or any suitable network enabling the screens to interact with each in accordance with the teachings of the present disclosure. The network can be controlled through a central server, or through one or more servers communicating with the central server. Further, the network is also enabled to receive remotely controlled instructions from a remote user.

The adaptive sport training system comprises of a target rendering module configured to display a target on the screens. The target rendering module is in communication with the screens and is configured to receive instructions from the adaptive sport training system or from the remote servers to display the target on any of the screens. In accordance to an additional embodiment, the target rendering module is configured to indicate on the first screen, the screen other than the first screen on which the next target is displayed. In accordance with a preferred embodiment, the target indicates a placement on the screen whereon the player is expected to hit an object, for example a ball used in any ball game such as football, soccer, etc. In accordance with an another embodiment, the target is an instruction to a player to do a specific activity, for example a player may be asked to do pushups, or engage with another player in the game. Further, the target rendering module can also be an LED image renderer, LCD Image Projector, an LED target projector, etc. having appropriate pixels and lumens configuration. They may be long throw, or short throw or ultra-short throw.

Further, the adaptive sport training system comprises of a target impact sensor module configured to sense impact of an object on the screens and to determine proximity of impact to the target. The target impact sensor module can sense the approximate position of the impact of a ball on the screens and match it with the position or placement of the target displayed by the target rendering module on the screens. In accordance with an embodiment, the target impact sensor module can sense subsequent impacts on the screen for a time period and determine a plurality of proximities of impact to the target for that time period.

In accordance with an embodiment, various configurations of infrared screens and/or touch sensitive or capacitive screens coupled to the target sensing module can be employed for the purpose of sensing impact of an object on the screen. In accordance with an embodiment, the target sensing module comprises of at least one line scan camera and a light source to capture an impact position of an object on the screens. The light source such as a laser generates the field of light to capture any object in the camera's field of view. In accordance with an embodiment, multiple types of cameras may be used with a light source for the purpose of sensing impact of an object on the screen.

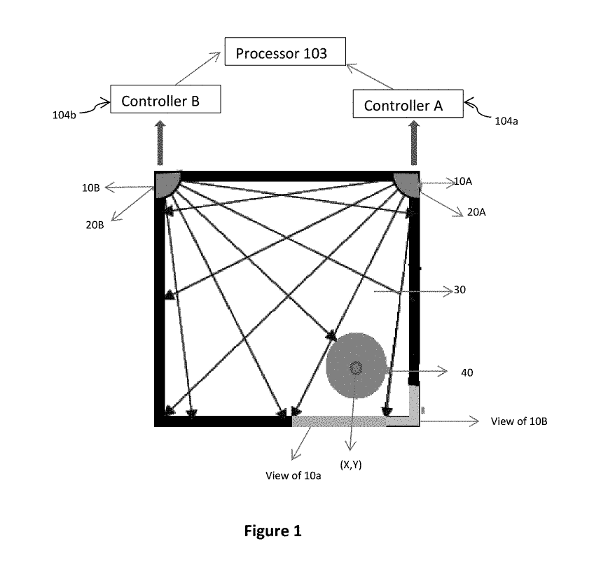

FIG. 1 shows an exemplary embodiment of a target sensing module comprising a pair of line scan cameras and two lines laser as the light source. As shown in the Figure, The line scan cameras, indicated as 10A and 10B are positioned on the top right and top left corners of the screen respectively. The line lasers are also positioned accordingly, indicated as 20A and 20B, top right and top left corners of the screen respectively. The cameras' field of view on the screen is indicated as 30. The top right line scan camera 10A focuses on the left vertical and the bottom right surface of the screen. The top left line scan camera 10B focuses on the right vertical and bottom left surface of the screen. The field of view (30) of the two line scan cameras 10A and 10B diagonally run and cross each other as shown in the FIG. 1. Further, retro reflectors may be placed along the opposite edge of the screen, not shown in the FIG. 1. The retro reflective strips reduce the light scattering. The line lasers project light on the retro reflective strips to generate a steady light source which is continuously sampled by the line scan cameras 10A and 10B. When an object referred to as projectile (40), penetrates the field of view (30), the line scan cameras 10A and 10B generate signals which can be further processed by a processor to provide the X and Y coordinates of the projectile's impact on the screen. As shown in the FIG. 1, line scan camera 10A generates signals which is processed by controller A (104a) and line scan camera 10B generates signals which is processed by controller B (104b), the controllers can be any microcontroller coupled to the processor (103) of the adaptive sport training system, explained below.

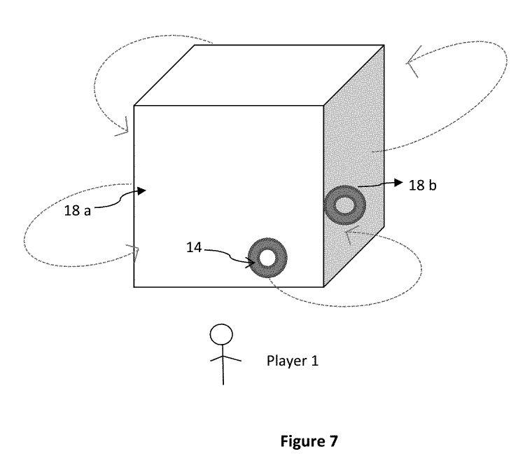

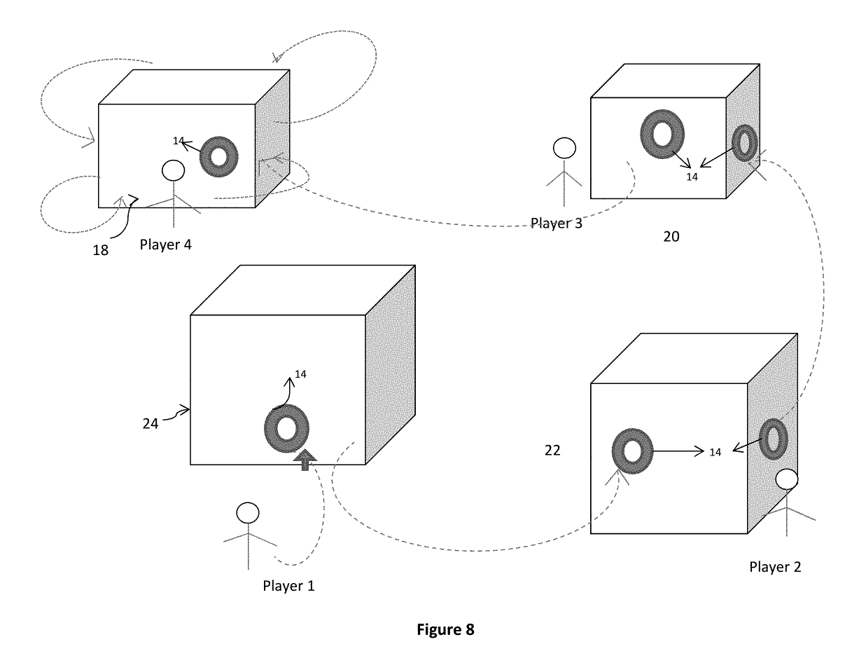

In accordance with an embodiment, the adaptive sport training system comprises of a processor configured to generate an impact score based on the proximity of the impact to the target. Further, the processor is in communication with the target rendering module and, and provides instructions to the target rendering module to display a subsequent target on any screen based on the impact score on that screen and also based on the impact score on other screens. FIG. 7 shows an example of displaying a subsequent target on the next screen of the cube based on the impact score on the previous screen. As shown in FIG. 7, the player 1 hits on the target 14 on screen 18a. Based on the impact score on 18a, the player is prompted or instructed to move to screen 18 b to hit the target 14 now displayed on the screen 18b, and further to screens 18c and 18d (the screens of the cube not shown in FIG. 7). In another example, shown in FIG. 8, multiple players playing on multiple cubes are shown, based on the impact score on cube 24, the player 1 can be prompted to move to one of the screens of cube 22, similarly the player 2 can be prompted to move to one of the screens of the cube 20 and player 3 can be prompted to move to one of the screens of the cube 18.

In accordance with a further embodiment, the processor is configured to determine a time period between two impacts on the first screen. When the time period is greater than a first predetermined threshold, the processor provides instructions to the target rendering module to decrease the target difficulty level. Additionally, if the time period is less than a second predetermined threshold, the processor provides instructions to the target rendering to increase the target difficulty level. For example, the subsequent target displayed on the screen can be increased or decreased in size or can be placed on a position on the screen which is easier to access such as around the center of the screen or can be placed in a position on the screen difficult to access such as around the corners of the screen. For example, a 2ft×2ft crosshair target may become a 1ft×1ft crosshair target to make gameplay more difficult and vice versa. In another example, a target is an instruction to a player to do a specific activity in accordance with an difficulty level, such as a the instructions may be for doing 50 pushups or sprint in one level of difficulty or the instruction may be for 5 pushups or jog to the next or subsequent target displayed on another screen. Another screen can be of a different cube placed at a distance from the player's screen's on which instructions is displayed.

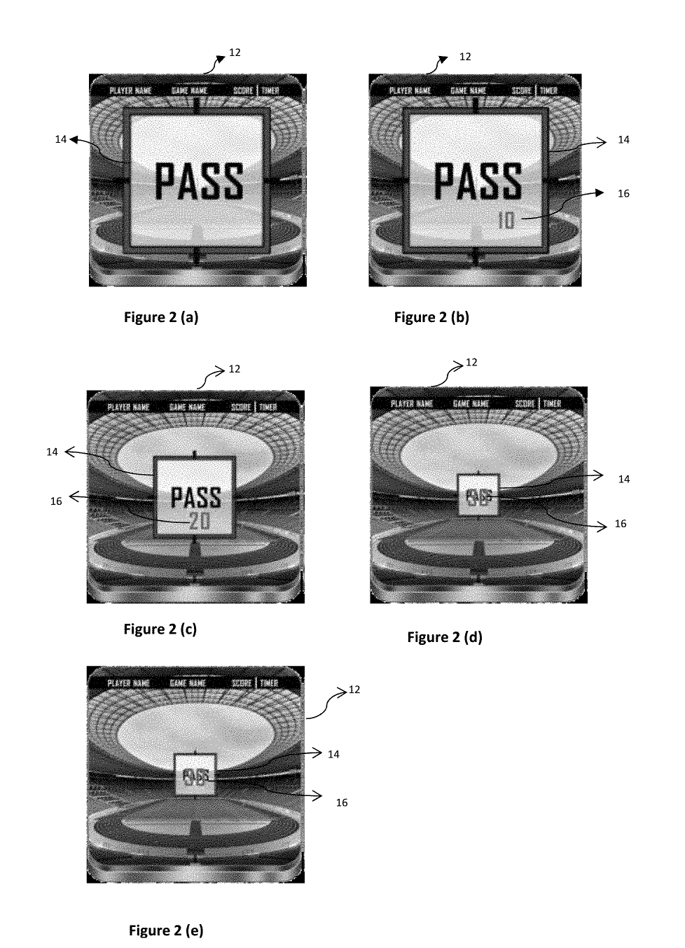

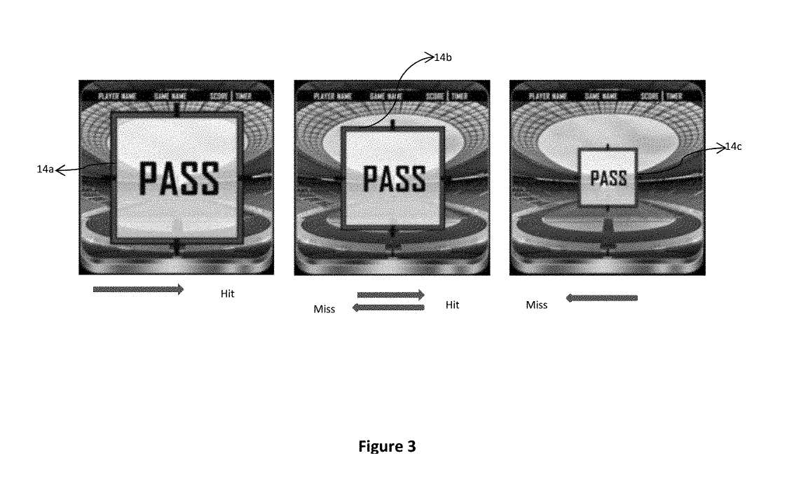

FIGS. 2 (a) to 2(e) describe a user interface displayed on a screen (12) by the target rendering module during the various phases of a game played on the adaptive sport training system. The FIGS. 2(a) to 2(e) show a rectangular shaped crosshair indicated as (14) representing a target to be hit or impacted. Further, from FIGS. 2(a) to 2(e), the subsequent target to be displayed on the screen reduces in size, showing an increased difficulty level, for every successful impact on the target. Every target indicates points (16) associated with the target, which increases for a more difficult target. In another example, as shown in FIG. 3, three user interfaces are shown in the order of reducing target size, 14a, 14b and 14c, indicating increased difficult levels of the target respectively. According to a successful impact or hit, the player proceeds to hit a more difficult level target, or on a miss impact or hit, the player goes back to the lower difficult level target.

In accordance with a further embodiment, the target rendering module can be instructed by the processor to increase or decrease the target difficulty level based on the impact score and/or the time required to attempt the target displayed on the same or another screen. For example, a target may stay on the screen for 7 seconds before the next target appears. On successful hit, the time duration of the next target may be 5 seconds to make it more difficult. If he misses, it may change from 7 seconds to 9 seconds to make it easier.

In accordance with a further embodiment, the adaptive sport training system comprises of an evaluation module configured to store and evaluate the impact score. Such evaluation can also include capturing and analyzing data indicating the accuracy and response time parameters of the players to respond to the target and/or the instructions displayed on the screens.

The following Figures shall now describe using the various embodiments of the adaptive sport training system as disclosed above.

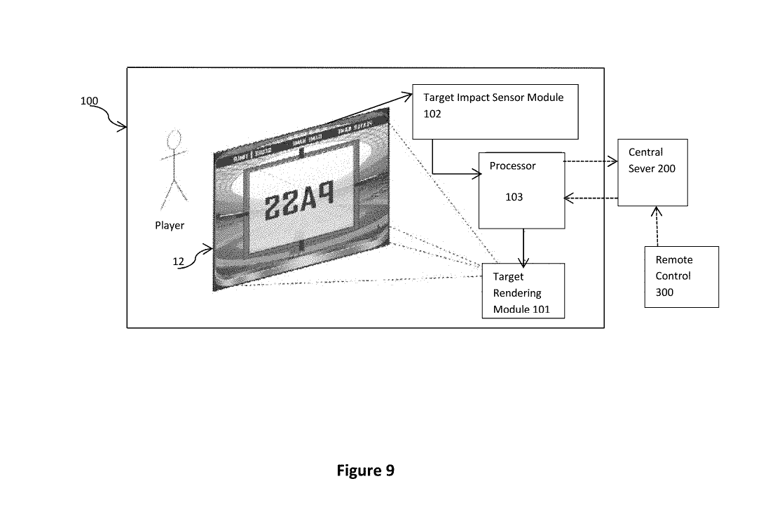

FIG. 9 shows an embodiment of the disclosed an adaptive sport training system (100). A single player 1 is shown playing on a first screen (12). The target rendering module (101) is configured to display targets on different positions on the screen (12). The target impact sensor module (102) senses impacts of an object on the screen (12) and determines the proximity of impact to the target. Further the processor (103) generates an impact score based on the proximity of the impact to the target and also determine a time period between two impacts on the screen (12), and provides further instructions to the target rendering module (101) to display a subsequent target on the screen (12) and further instructions to increase or decrease the target difficulty level based on the impact score and/or the time required to attempt the target displayed on the screen (12). Additionally, the adaptive sport training system (100) can be in communication with a central server, as shown in FIG. 9, wherein the processor (103) is in communication with a central server (200) and is configured to send to and receive instructions from the central server (200). Further, the central server (200) can further receive instructions from a remote server or remote control (300). Based on the received instructions from the central server (200) and/or remote control (300), the processor (103) accordingly provides instructions to target rendering module (101) to display subsequent targets on screen (12).

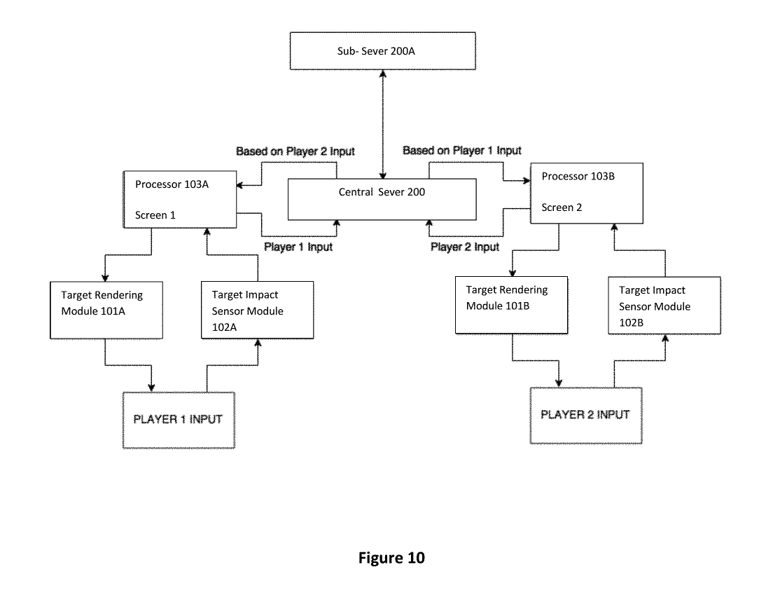

FIG. 10 shows another embodiment of the disclosed adaptive sport training system (100), wherein the target rendering module is configured to display a subsequent target on a screen based on the impact score for that screen and the impact score for another screen. As an example shown in FIG. 10, the target rendering module 101A displays target to player 1 on screen 1 based on the input or an object impact by the player 1 on screen 1 and also based on the input or an object impact by player 2 on screen 2. Similarly, the target rendering module 101B displays target to player 2 on screen 2 based on the input or an object impact by the player 2 on screen 2 and also based on the input or an object impact by player 1 on screen 1. Further, FIG. 10 shows that player 1's input is sensed by a target impact sensor module (102A) in communication with screen 1, which provides the proximity of the impact to a processor (103A) for the screen 1. Similarly, it is shown that player 2's input is sensed by a target impact sensor module (102B) in communication with screen 2, which provides the proximity of the impact to a processor (103B) for the screen 2. Processor (103A) and processor (103B) provide impact scores or details of the impact proximities to the central server (200). Processor (103A) can receive instructions for displaying the subsequent target on screen 1 based on player 1 input and player 2 inputs from the central server (200), and provide such instructions to the target rendering module (101A) to display the subsequent target to player 1 on screen 1. Similarly, processor (103B) can receive instructions for displaying the subsequent target on screen 2 based on player 2 input and player 1 input from the central server (200), and provide such instructions to the target rendering module (101B) to display the subsequent target to player 2 on screen 2. The central server (200) can receive further instructions from sub-server (200A) which can be configured to receive further remote controlled instructions from a remote user. The target to be displayed on screen 1 and screen 2 can be further based on instructions received from sub-server (200A) through the central server (200).

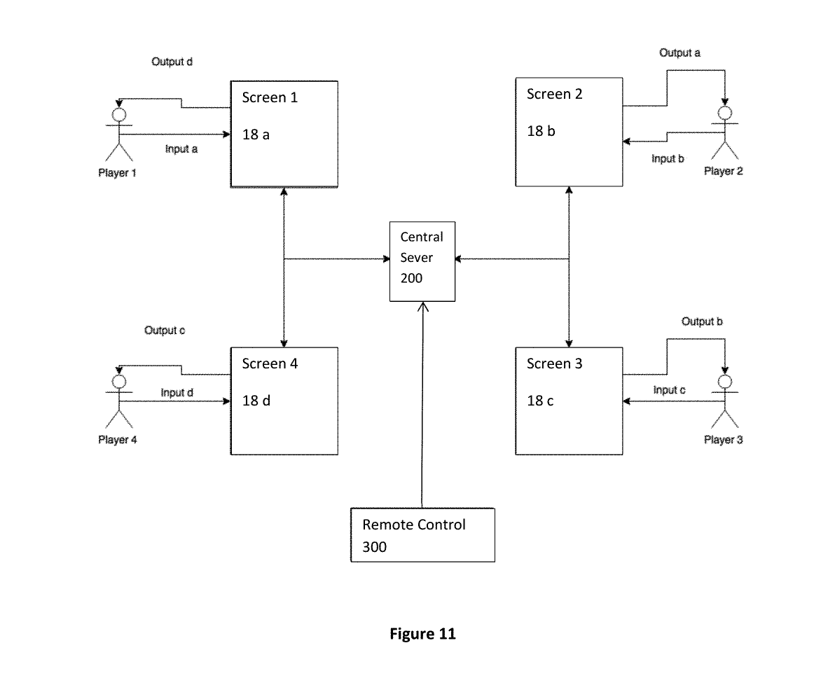

FIG. 11 shows an example of a plurality of screens in communication with each other through a central server. As shown in FIG. 11, four screens are shown as screen 1 (18a), screen 2(18b), screen 3 (18c) and screen (18d). Each of the four screens receives inputs from four different players, shown as player 1, player 2, player 3 and player 4 respectively. The input on a screen represents the impact received from a player on the respective screen. The inputs are all received on a central server (200) which provides instructions to display a subsequent target or output on each of the screens, which is based on an input received from all the screens. For example, the central server (200) provides instruction for a subsequent target ‘output d’ to be displayed on screen 1 (18a) based on input ‘input a’, ‘input b’ ‘input c’ and ‘input d’ received from screen 1(18a), screen 2(18b), screen 3 (18c) and screen (18d), respectively. Also, as shown in FIG. 11, the central server (200) can receive instruction from remote control (300) to provide output to any of the screens.

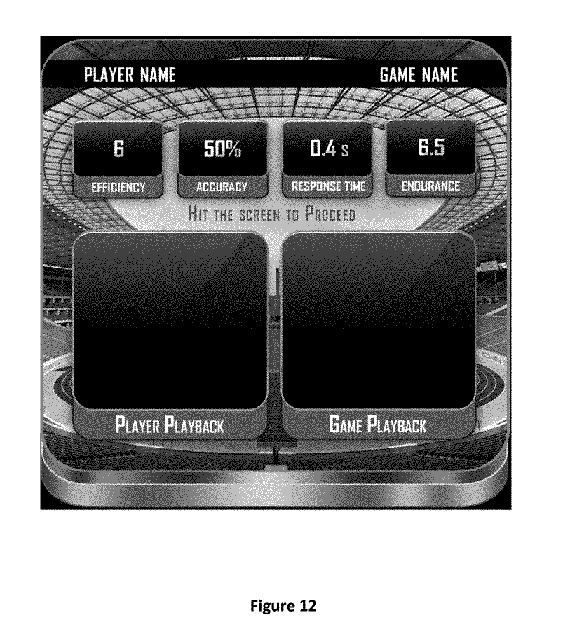

FIG. 12 shows an example of a user interface representing an evaluation report generated by the evaluation module. The evaluation report includes efficiency, accuracy, response time and endurance of the player, based on an impact by the player to the target received on the shown screen.

In accordance with further embodiments, wherein the target displayed on the one or more screens is an instruction to the players engaged in the sport, the adaptive sport training system comprise of evaluation module coupled to cameras to record the videos of the players' activities such that the evaluation module can further evaluate the quantitative, such as accuracy and response time, and qualitative analysis for the players. Further, the evaluation module can be in communication with one or more remote controlled servers receiving instructions from the remote users such as a coach of the players engaged in the sport. Based on the evaluation report of the evaluation module, the remote controlled server can provide further instructions to the adaptive sport training system, for displaying the target or instructions on the screens of the players. Such instructions to be displayed on the screen for the players to perform can depend upon the physical fitness requirements of a sport.

In accordance with further embodiments, the evaluation module is coupled to heat mapping sensors, motion capture sensors, calorie meters, heart rate calculator etc. to monitor the players engaged in the sport using the disclosed adaptive sport training system.

### SPECIFIC EMBODIMENTS

An adaptive sport training system is disclosed. The adaptive sport training system comprises of a first screen and a second screen in communication with each other, a target rendering module configured to display a target on the first screen and the second screen, a target impact sensor module configured to sense impact of an object on the first screen and the second screen and to determine a proximity of impact to the target, and a processor configured to generate an impact score based on the proximity of the impact to the target, wherein the target rendering module is configured to display a subsequent target on the first screen based on the impact score for the first screen and the impact score for the second screen.

Such system further comprises of three or more screens in communication with each other.

Such system wherein the target rendering module is configured to indicate on the first screen, the screen other than the first screen on which the next target is displayed.

Such system wherein the target impact sensor module comprises of a light source for generating a light field.

Such system wherein the target impact sensor module comprises of at least one line scan camera.

Such system wherein the target rendering module is configured to increase or decrease the target difficulty level based on the impact score and/or the time required to attempt the target displayed on the same or another screen.

Such system wherein the processor is configured to determine a time period between two impacts on the first screen, wherein on the time period being greater than a first predetermined threshold, causing the target rendering module to decrease the target difficulty level, or on the time period being less than a second predetermined threshold, causing the target rendering module to increase the target difficulty level.

Such system wherein the target rendering module is configured to display a target on the three or more screens in communication with each other, the target impact sensor module configured to sense impact of an object on the three or more screens and to determine a proximity of impact to the target, and the processor configured to generate an impact score based on the proximity of the impact to the target, wherein the target rendering module is configured to display a subsequent target on any of the three or more screens based on the impact score for the three or more screens.

Such system wherein the target rendering module is configured to increase or decrease the target difficulty level based on the impact score and/or the time required to attempt the target displayed on the same or another screen.

Such system wherein the processor is configured to determine a time period between two impacts on the first screen, wherein on the time period being greater than a first predetermined threshold, causing the target rendering module to decrease the target difficulty level, or on the time period being less than a second predetermined threshold, causing the target rendering module to increase the target difficulty level.

Such system further comprises at least one input module in communication with the target rendering module and configured to receive further instructions for target placement, causing the target rendering module configured to display a subsequent target on any of the screens.

Such system further comprises of an evaluation module configured to store and evaluate the impact score.

### INDUSTRIAL APPLICABILITY

The disclosed adaptive sport training system can be used to promote fitness, sports training and scouting talented individuals by engaging multiple players across various age groups and economic segments through a gaming experience. The disclosed adaptive sport training system can also be used for education purposes to teach primary academics to children such as colors, alphabets, numbers etc. by accordingly creating visuals on the screens and setting target for impact on the displayed color, alphabets and numbers.

1. An adaptive sport training system comprising:
a first screen and a second screen in communication with each other;
a target rendering module configured to display a target on the first screen and the second screen;
a target impact sensor module configured to sense impact of an object on the first screen and the second screen and to determine a proximity of impact to the target; and
a processor configured to generate an impact score based on the proximity of the impact to the target;
wherein the target rendering module is configured to display a subsequent target on the first screen based on the impact score for the first screen and the impact score for the second screen.

2. The adaptive sport training system of claim 1, further comprising three or more screens in communication with each other.

3. The adaptive sport training system of claim 1, wherein the target rendering module is configured to indicate on the first screen, the screen other than the first screen on which the next target is displayed.

4. The adaptive sport training system of claim 1, wherein the target impact sensor module comprises of a light source for generating a light field.

5. The adaptive sport training system of claim 1, wherein the target impact sensor module comprises of at least one line scan camera.

6. The adaptive sport training system of claim 1, wherein the target rendering module is configured to increase or decrease the target difficulty level based on the impact score and/or the time required to attempt the target displayed on the same or another screen.

7. The adaptive sport training system of claim 1, wherein the processor is configured to determine a time period between two impacts on the first screen, wherein on the time period being greater than a first predetermined threshold, causing the target rendering module to decrease the target difficulty level, or on the time period being less than a second predetermined threshold, causing the target rendering module to increase the target difficulty level.

8. The adaptive sport training system of claim 2, wherein:
the target rendering module is configured to display a target on the three or more screens in communication with each other;
the target impact sensor module is configured to sense impact of an object on the three or more screens and to determine a proximity of impact to the target;
the system further comprises a processor configured to generate an impact score based on the proximity of the impact to the target; and
the target rendering module is configured to display a subsequent target on any of the three or more screens based on the impact score for the three or more screens.

9. The adaptive sport training system of claim 8, wherein the target rendering module is configured to increase or decrease the target difficulty level based on the impact score and/or the time required to attempt the target displayed on the same or another screen.

10. The adaptive sport training system of claim 8, wherein the processor is configured to determine a time period between two impacts on the first screen, wherein on the time period being greater than a first predetermined threshold, causing the target rendering module to decrease the target difficulty level, or on the time period being less than a second predetermined threshold, causing the target rendering module to increase the target difficulty level.

11. The adaptive sport training system of claim 1, further comprising at least one input module in communication with the target rendering module and configured to receive further instructions for target placement, causing the target rendering module configured to display a subsequent target on any of the screens.

12. The adaptive training system of claim 1, further comprising an evaluation module configured to store and evaluate the impact score.
